(19) United States
(12) Patent Application Publication
(10) Pub. No.: US 2025/0056144 A1
(43) Pub. Date: Feb. 13, 2025

(54) CAP ILLUMINATION

(71) Applicant: HARMAN BECKER AUTOMOTIVE SYSTEMS GmbH, Karlsbad-Ittersbach (DE)

(72) Inventor: Marcel PILGAARD HAVEMANN, Hjerm (DK)

(21) Appl. No.: 18/776,049

(22) Filed: Jul. 17, 2024

(30) Foreign Application Priority Data
Aug. 11, 2023 (EP) 23191134.8

(51) Int. Cl. H04R 1/02; H04R 7/02; H04R 9/06

(52) U.S. Cl. CPC H04R 1/028; H04R 7/02; H04R 9/06

(57) ABSTRACT

Techniques for cap illumination include an audio speaker configured to emit sound in a main sound emitting direction. The audio speaker includes a voice coil, a diaphragm connected to the voice coil and configured to move together with the voice coil parallel to the main sound emitting direction, a magnet configured to generate a magnetic field in which the voice coil is moving, and a circuit board located between the magnet and the diaphragm. The circuit board includes one or more light sources configured to emit light in the main sound emitting direction and illuminate a surface of the diaphragm facing the circuit board. The diaphragm includes a plurality of transparent areas that permit light from the at least one light source to pass through the diaphragm.

### CROSS-REFERENCE TO RELATED APPLICATIONS

This application claims priority of European Patent Application titled “CAP ILLUMINATION,” filed on Aug. 11, 2023, and having Ser. No. 23/191,134.8. The subject matter of this related application is hereby incorporated herein by reference.

### TECHNICAL FIELD

The present application relates to an audio speaker and more particularly to an audio speaker configured to emit light.

### BACKGROUND

Audio speakers are used for generating and emitting acoustic sound waves. This is mainly achieved by causing movements of a movable diaphragm by means of a voice coil connected to the diaphragm. Furthermore, there is an increasing need to provide audio speakers which are illuminated with light. For an illumination of an audio speaker using light sources provided at or in the speaker it has to be made sure that the space requirements are not greatly increased when a light source is added to the loudspeaker, especially in the environment when the speaker is installed in a vehicle where limited space is available for the audio speaker. Furthermore, it has to be made sure that the light source is located at a position where a heating of the light source is avoided as the repeated heating of the light source used for illuminating the speaker would decrease the lifetime of the light source.

Accordingly, a need exists to provide an audio, which can be illuminated, has small space requirements and where the heating of the light source is avoided.

### SUMMARY

This need is met by the features of the independent claim. Further aspects are described in the dependent claims.

According to a first aspect an audio speaker is provided configured to emit sound in a main sound emitting direction, wherein the audio speaker comprises a voice coil and a diaphragm connected to the voice coil and configured to move together with the voice coil parallel to the main sound emitting direction. The speaker furthermore contains a magnet configured to generate a magnetic field in which the voice coil is moving and a circuit board located between the magnet and the diaphragm wherein the circuit board comprises at least one light source configured to emit light in the main sound emitting direction and configured to illuminate, in direction of the main sound emitting direction, a lower surface of the diaphragm. The diaphragm furthermore comprises a plurality of transparent areas configured to let pass the light from the at least one light source.

The audio speaker as described above is a speaker having low space requirements and only very little space is needed for providing the circuit board with the at least one light source. Furthermore, the position between the magnet and the diaphragm makes sure that any heat generated by the voice coil and the currents flowing in the voice coil does not heat up the at least one light source. Furthermore, an efficient illumination of the diaphragm and the transparent areas is obtained so that a variety of light effects can be generated visible to a user of the audio speaker.

In some examples, the circuit board is provided on an upper surface of the magnet as seen in the direction of the main sound emitting direction. By placing the circuit board and the light sources on the magnet, the lower surface of the diaphragm can be illuminated efficiently, and this illumination is visible from the outside of the speaker through the transparent areas provided in the diaphragm.

It is to be understood that the features mentioned above and features yet to be explained below can be used not only in the respective combinations indicated, but also in other combinations or in isolation without departing from the scope of the present invention. Features of the above-mentioned aspects and embodiments described below can be combined with each other in other embodiments unless explicitly mentioned otherwise.

### BRIEF DESCRIPTION OF THE DRAWINGS

Other features and advantages of the application will become apparent to one with skill in the art upon examination of the following detailed description and figures. The features and effect of the application will especially become apparent from the following detailed description when read in conjunction with the accompanying drawings in which like reference numerals refer to like elements.

FIG. 1 shows a schematic cross-sectional view of an audio speaker with an illumination of the diaphragm.

FIG. 2 shows a schematic top view of a printed circuit board comprising light sources configured to illuminate a diaphragm of the speaker shown in FIG. 1.

FIG. 3 shows a schematic architectural view of a system used to control.

FIG. 4 shows a schematic top view of the diaphragm when looking into the speaker from the front side.

FIG. 5 shows a schematic sectional view through the diaphragm.

### DETAILED DESCRIPTION

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are to be illustrative only.

The drawings are to be regarded as being schematic representations, and elements illustrated in the drawings are not necessarily shown to scale. Rather, the various elements are represented such that their function and general purpose becomes apparent to a person skilled in the art. Any connection or coupling between functional blocks, devices, components of physical or functional units shown in the drawings and described hereinafter can also be implemented by an indirect connection or coupling. A coupling between components can be established over a wired or wireless connection. Functional blocks can be implemented in hardware, software, firmware, or a combination thereof.

In the present context the term ‘audio speaker’ should be interpreted to mean a device that is capable of generating and emitting acoustic waves by actuating a movable diaphragm into a main sound emission direction. Thus, the audio speaker according to various embodiments includes a movable diaphragm and a voice coil arranged to actuate the movable diaphragm. During operation of the audio speaker, voice coil receives appropriate input signals and operates in response to the received input signals in such a manner that it causes the movable diaphragm to move or vibrate and thereby generate acoustic waves in accordance with the input signals.

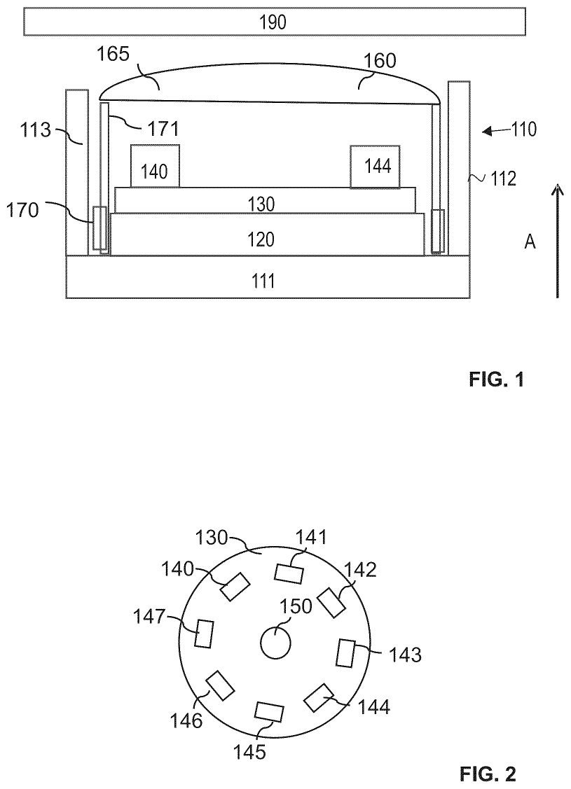

Referring to FIG. 1, an audio speaker 100 is provided which comprises an enclosure 110 including a bottom part 111 at a rear end of the speaker and two side walls 112, 113. The speaker 100 includes a magnet 120 generating a magnetic field in which a voice coil 170 is located connected to a diaphragm 160 which in the present case is a dome shaped diaphragm. The voice coil 170 is immersed in the magnetic field generated by the magnet 120 and when signal current flows in the voice coil a force is generated that produces a back-and-forth motion of the voice coil which is connected to the diaphragm 160. With the movement of the diaphragm the audio speaker 100 is configured to emit sound into a main sound emission direction which is indicated by arrow A in FIG. 1. The voice coil can have a specific type of oil on the voice coil such as a ferrofluid in order to enhance a heat transfer from the coil to the surrounding magnet or magnet assembly. The space into which the sound is mainly emitted is the space in front of the loudspeaker and a user looking onto the audio speaker in the direction opposite the main sound emission direction is looking at a front surface 165 of the diaphragm, if no protective cover such as a grille 190 is located in front of the speaker 100. For the sake of clarity a control unit configured to generate the signals needed to move the voice coil is not shown in FIG. 1. A support structure 171 is connecting the voice coil 170 and the diaphragm 160.

The audio speaker furthermore comprises a circuit board 130 onto which one or a plurality of light sources 140 are provided. In the embodiment shown the circuit board 130 is directly provided on an upper surface of the magnet wherein the direction upper or lower surface are defined relative the main sound emitting direction. One side of the circuit board is facing the magnet 120 and the other side of the circuit board is facing the diaphragm. 160. As will be explained further below in connection with FIG. 4 the diaphragm 160 includes a plurality of holes or transparent areas which are configured to let pass the light generated by the light sources 140.

FIG. 2 shows a schematic top view of the circuit board 130 which contains the different light sources 140-147. In the situation shown the light sources are arranged on a circle on the circuit board 130 and in the embodiment shown 8 light sources such as LEDs are provided. However, it should be understood that any number of light sources can be provided even only a single light source 140 can be provided on the circuit board 130. Furthermore the light sources can be arranged in any other pattern on the board 130. A through hole 150 is provided in a central part of the circuit board 130 for wiring and ventilation of the audio speaker. The LEDs 140-147 can be implemented as single color LED emitting white light, or light of any other color, however it should be understood that each of the LEDs can also be configured as an RGB LED which comprises a red, green and blue LED element so that a vast variety of different colors can be generated by each of the light sources.

In the present context, the term light source is a device that is configured to generate light, electromagnetic waves, such as within a wavelength range which is visible to the human eye. However, it should not be ruled out that the light source is capable of generating electromagnetic waves at wavelengths outside the visible range such as the infrared or ultraviolet range. The light source could be or include light emitting diodes, LEDs, organic LEDs, a laser, a plasma lamp, or any other suitable kind of light source.

Each of the light sources 140-147 shown in FIG. 2 can be controlled individually concerning the color and the light output generated by each of the light sources. However, it should be understood that the different light sources can also be controlled in groups, by way of example a first group containing light sources 140, 142, 144, 146 and a second group containing light sources 141, 143, 145, and 147. A further contemplated grouping is that light sources 141, 142 are grouped together, whereas another group contains the light sources 143 and 144 etc., so that in this embodiment 2 light sources are controlled together in the same way. The group can also contain light sources arranged on an opposite side of the circular arrangement so that one group contains the light sources 140 and 144, another group the light sources 141 and 145 and so on. By grouping several of the light sources together, the wiring and controlling of the light sources can be facilitated.

In an embodiment not shown, a lens is provided between the light sources and the diaphragm in order to create different light effects or in order to enhance the dispersion of light. In some examples, there is a single lens for each light source or a lens for a subgroup of light sources provided on the circuit board, or a single lens is provided for all light sources provided on the board.

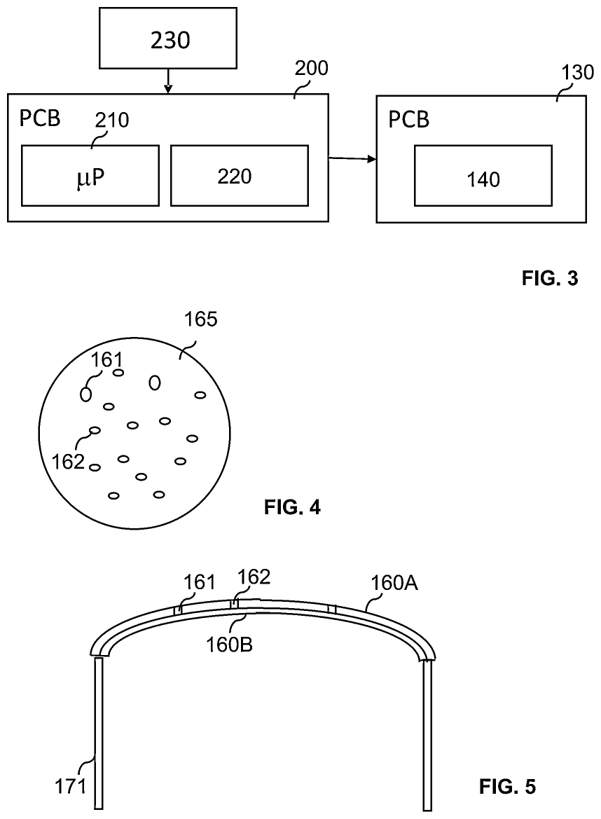

FIG. 3 shows a schematic view of a system that might be used to control the illumination of the audio speaker 100 shown in FIG. 1. FIG. 3 schematically shows the circuit board 130 which is provided in the audio speaker 100 of FIG. 1 which comprises the plurality of LEDs or light sources 140. The system can furthermore comprise a second or additional circuit board 200 on which a processing unit 210 is provided which is configured to control and operate the loudspeaker and/or the light sources on the circuit board. A driver 220 is provided configured to drive the light sources. The external circuit board 200 is connected to the circuit board 130 provided in the audio speaker. Furthermore, a power source 230 provides power to the external circuit board 200 and also to the circuit board 130 and the light sources provided in the audio speaker 100. The power source can be an external unit, but can also be located on the circuit board 200 or even on the circuit board 130.

In another embodiment not shown, the processing unit 210 and the driver 220 are implemented on the circuit board 130 provided within the audio speaker 100.

FIG. 4 shows a schematic top view of the diaphragm 160 with the protective cover 190 being removed. The diaphragm comprises several holes 161 and 162 which are distributed over the dome-shaped diaphragm. The holes 161 and 162 can be generated by a laser or similar means so that small holes are created which are illuminated from the inside of the speaker by the light sources 140 to 147. The holes should be airtight and can include a resin painted on the inner side of the diaphragm. The resin should be transparent in order to let pass the light generated by the light sources. The resin could cover the complete inner surface of the diaphragm or could only be provided around the holes and covering the holes.

FIG. 5 shows an implementation of the diaphragm including a first opaque layer 160A which comprises the holes 161 and 162. In order to keep the loudspeaker airtight a second transparent layer 160B (a resin layer) can be provided which covers at least the transparent areas generated by the holes. As indicated, the second layer 160B can cover the whole inner surface of the diaphragm or can be provided only in and around the holes 161 or 162.

The holes 161 and 162 can have different sizes so that the light emitted through the holes differs giving an impression of stars in a ceiling having different luminosity. Furthermore, the positions of the different holes in the diaphragm can vary and can be randomly distributed over the surface. Furthermore, the holes can also be provided with a defined pattern on the surface in order to provide a defined illumination pattern on the diaphragm 160 depending on the distribution of the holes on the diaphragm.

Depending on the size of the holes, the number of holes and the position of the holes different visual effects can be obtained and the visual effects can be controlled depending on the light output of the different light sources, the grouping of the light sources and the colors emitted by the different light sources.

Summarizing a variety of different light effects can be generated with an audio speaker having limited space requirements.

From the above said some general conclusions can be drawn:

The circuit board 130 can be located, in direction of the main sound emitting direction on an upper surface of the magnet 120.

The diaphragm 160 can comprise a first opaque layer 160A comprising the plurality of transparent areas or holes and a second transparent and airtight layer 160B covering at least the plurality of transparent areas. This helps to maintain an airtight volume inside the loudspeaker.

The plurality of transparent areas in the first opaque layer can be provided as holes in the first opaque layer and the airtight layer can cover at least the holes.

On the circuit board 130 a single light source or several light sources can be provided and it is contemplated that the light sources can be grouped in different groups of light sources wherein the light sources can be controlled in such a way that the light emitted by the light sources are controlled on a per group basis so that the light sources of one group are controlled together and emit the same amount of light and the same colors.

The plurality of light sources can be arranged in a ring-shape pattern on the circuit board.

Furthermore, it is contemplated that the plurality of transparent areas can have a circular shape and can have the same or different diameters. The transparent areas can be implemented as holes generated in the diaphragm.

The audio speaker can be configured as tweeter configured to emit sound mainly in a frequency range above 1000 Hz.

The diaphragm can have a dome-shaped surface and the plurality of holes or transparent areas can be distributed over the dome-shaped surface either in a regular or irregular pattern.

The circuit board 130 can furthermore comprise a ventilation hole 150 as shown in FIG. 2.

The system can be provided which comprises the audio speaker 100 and the driver 220 which is configured to control the light source. The driver can be provided on an additional circuit board such as the external circuit board 200 located outside the audio speaker.

What is claimed is:

1. An audio speaker configured to emit sound in a main sound emitting direction, the audio speaker comprising:
a voice coil;
a diaphragm connected to the voice coil and configured to move together with the voice coil parallel to the main sound emitting direction;
a magnet configured to generate a magnetic field in which the voice coil is moving; and
a circuit board located between the magnet and the diaphragm, the circuit board comprising one or more light sources configured to:
emit light in the main sound emitting direction, and
illuminate a surface of the diaphragm facing the circuit board, wherein the diaphragm comprises a plurality of transparent areas that permit light from the one or more light sources to pass through the diaphragm.

2. The audio speaker of claim 1, wherein the circuit board is located on an upper surface of the magnet that faces the main sound emitting direction.

3. The audio speaker of claim 1, wherein the diaphragm comprises:
a first opaque layer comprising the plurality of transparent areas; and
a second transparent and airtight layer covering at least the plurality of transparent areas.

4. The audio speaker of claim 3, wherein the plurality of transparent areas in the first opaque layer are provided as holes in the first opaque layer, wherein the second transparent and airtight layer covers at least the holes.

5. The audio speaker of claim 1, wherein the one or more light sources comprises a plurality of light sources provided on the circuit board.

6. The audio speaker of claim 5, wherein the plurality of light sources are grouped in different groups of light sources, the audio speaker comprising a control unit configured to control the light emitted by the light sources on a per group basis.

7. The audio speaker of claim 6, wherein the plurality of light sources are arranged in a ring shape pattern on the circuit board.

8. The audio speaker of claim 1, wherein the plurality of transparent areas have a circular shape.

9. The audio speaker of claim 8, wherein the plurality of transparent areas have different diameters.

10. The audio speaker of claim 1, further being configured as tweeter configured to emit sound mainly in a frequency range above 1000 Hz.

11. The audio speaker of claim 1, wherein the diaphragm has a dome shaped surface.

12. The audio speaker of claim 11, wherein the plurality of transparent areas are distributed over the dome shaped surface.

13. The audio speaker of claim 1, wherein the circuit board comprises a ventilation hole.

14. A system comprising:
an audio speaker configured to emit sound in a main sound emitting direction, the audio speaker comprising:
a voice coil;
a diaphragm connected to the voice coil and configured to move together with the voice coil parallel to the main sound emitting direction;
a magnet configured to generate a magnetic field in which the voice coil is moving; and
a circuit board located between the magnet and the diaphragm, the circuit board comprising one or more light sources configured to:
emit light in the main sound emitting direction, and
illuminate a surface of the diaphragm facing the circuit board, wherein the diaphragm comprises a plurality of transparent areas that permit light from the one or more light sources to pass through the diaphragm; and
a driver configured to control the one or more light sources.

15. The system of claim 14, further comprising:
an additional circuit board provided outside the audio speaker on which the driver is located.

16. The system of claim 14, wherein the circuit board is located on an upper surface of the magnet that faces the main sound emitting direction.

17. The system of claim 14, wherein the diaphragm comprises:
a first opaque layer comprising the plurality of transparent areas; and
a second transparent and airtight layer covering at least the plurality of transparent areas.

18. The system of claim 14, wherein the one or more light sources comprises a plurality of light sources provided on the circuit board.

19. The system of claim 14, wherein the plurality of transparent areas have a circular shape.

20. The system of claim 14, wherein the plurality of transparent areas have different diameters.
